(19) United States
(12) Patent Application Publication
(10) Pub. No.: US 2017/0279397 A1
(43) Pub. Date: Sep. 28, 2017

(54) PASSENGER TRANSPORT SYSTEM HAVING AT LEAST ONE INVERTER

(71) Applicant: Inventio AG, Hergiswil (CH)

(72) Inventors: Esteban Marks, Züruch (CH); Michael Matheisl, Vösendorf (AT); Karl Weinberger, Immensee (CH)

(21) Appl. No.: 15/514,002

(22) PCT Filed: Jul. 21, 2015
(86) PCT No.: PCT/EP2015/066673

§ 371 Date: Mar. 24, 2017

(30) Foreign Application Priority Data
Sep. 24, 2014 (EP) 14186208.6

(51) Int. Cl. H02P 27/06; H02S 10/20; B66B 13/14; B66B 23/10; B66B 23/24; B66B 23/12

(52) U.S. Cl. CPC H02P 27/06; B66B 23/24; B66B 23/12; B66B 13/143; B66B 23/10; H02S 10/20; B66B 21/02

(57) ABSTRACT

A passenger transport system includes a three-phase drive motor, a control device and an inverter module having power semiconductor switches. The gate electrodes of the power semiconductor switches are driven directly by the control device. The inverter module is connected on the input side to a DC source and on the output side to the three-phase drive motor. Between the DC source and the inverter module there is a DC circuit, wherein drive signals that can be modulated on the DC circuit can be generated by the control device, and the inverter module has a demodulator, by which demodulator the drive signals can be converted into control voltages assigned to the individual gate electrodes of the power semiconductor switches.

### FIELD

The invention relates to a passenger transport system, in particular an escalator, a moving walkway or an elevator system.

### BACKGROUND

Passenger transport systems of the aforementioned type have a three-phase AC drive motor and a control device, wherein the control device processes operation signals of the passenger transport system and controls the three-phase AC drive motor taking into account the operation signals. The operation signals originate, for example, from the main switch for switching on or switching off the passenger transport system; from a wide variety of sensors such as safety switches, pulse generators, encoders and the like; and from input units, via which the users can perform inputs.

The control device comprises at least one computing unit, one main memory and one non-volatile memory having a control program that is required to control and/or regulating the passenger transport system. Furthermore, such a control device can contain interfaces and input modules necessary for servicing the passenger transport system and for diagnostics and have a power supply.

A three-phase AC voltage is required to operate the three-phase AC drive motor. A frequency converter is preferably used in passenger transport systems because most power supply networks provide AC voltage having a constant frequency of 50 Hz or 60 Hz. The three-phase AC drive motor is thus connected to the power supply network via the frequency converter. A passenger transport system can be an escalator, a moving walkway or an elevator system.

In the case of elevator systems, as disclosed, for example, in EP 1 518 815 A1, the control device is located in an area of an elevator landing door. The frequency converter is usually arranged in the elevator shaft near the elevator motor. This is because frequency converters generate a significant amount of waste heat via their power semiconductor switches. Furthermore, their electrical and/or magnetic fields, or electrical and/or magnetic waves, may seriously disturb the control device. In addition, electromechanical contactors and/or relays, which generate considerable switching noises, are arranged in the elevator shaft between the frequency converter and the power network. Choking coils of the frequency converter also generate considerable operating noises, these noises being another reason the frequency converter is also preferably arranged in the elevator shaft.

In escalators and moving walkways, the control device and the frequency converter are usually housed near the three-phase AC drive motor. To solve the aforementioned problem of the waste heat and noise pollution, U.S. Pat. No. 5,135,097 A suggests spatially separating the control device and the drive motor from the frequency converter and the transformer. The waste heat is given off to the surroundings via the walls and covers of the machine spaces.

Today, frequency converters and inverters are offered by various manufacturers as finished units and incorporated into the aforementioned passenger transport systems. The frequency converters have a static or controlled rectifier, a DC voltage circuit with at least one capacitor and/or inductive load and an inverter with power semiconductor switches. Furthermore, the frequency converter or inverter has a converter controller that receives and further processes the control data of the control device.

The control data of the control device transmitted to the converter controller in chronological sequence include, for example, an acceleration profile, a delay profile, the speed during slow travel or the nominal speed to be reached in machine-readable form. From this control data, the converter controller generates trigger signals or control voltages that are applied to the gate electrodes of the power semiconductor switches of the inverter. If a frequency converter having feedback capability is used, the rectifier also has power semiconductor switches whose trigger signals, which are applied to the gate electrodes, are generated in the converter controller.

The generation of the trigger signals in the form of control voltages requires high computing power from the processor of the converter controller. Furthermore, there must be at least one main memory and at least one non-volatile memory for storing the algorithms in the converter controller. Using these algorithms from the control data of the control device, the processor of the converter controller generates control voltages and trigger currents, which are applied to the gate electrodes of the power semiconductor switch. For the sake of improved readability, there is no mention of trigger currents, even if small trigger currents always flow when control voltages are applied to the gate electrodes.

The converter controller is quite expensive due to the necessary components, such as a processor, main memory, memory unit and stabilized low voltage supply. In addition, the shielding of the converter controller and the waste heat of the power semiconductor switches require an additional installation effort within the frequency converter. In particular, the waste heat also affects the service life of the converter controller. Furthermore, the frequency converters designed as finished units require a fairly large installation space having sufficient air exchange so that it does not become too hot in the installation space due to the waste heat. However, modern passenger transport systems are designed in such a way that they require minimum installation space, allowing, for example, the available sales space in a department store to be maximized.

### SUMMARY

An object of the present invention is to create a power supply for a three-phase AC drive motor of a passenger transport system that is cost-effective, does not require much installation space and whose waste heat can be used in as beneficial a manner as possible.

This object is achieved by a passenger transport system that has a three-phase AC drive motor and a control device, wherein the control device processes operation signals of the passenger transport system and controls the three-phase AC drive motor taking into account the operation signals. The passenger transport system has at least one inverter module with power semiconductor switches, wherein the gate electrodes of the power semiconductor switches are triggered directly by the control device. The inverter module is connected to a DC voltage source on the input side and to a three-phase AC drive motor on the output side. Furthermore, there is a DC voltage circuit between the DC voltage source and the inverter module, wherein the control device can generate trigger signals that can be modulated to the DC voltage circuit. The inverter module has a demodulator, the demodulator being able to convert the trigger signals into control voltages that are associated with the individual gate electrodes of the power semiconductor.

The inverter module within the meaning of the present invention is a module that only has power semiconductor switches but not its own converter controller. The control signals generated to trigger the power semiconductor switches or the control voltages applied to the gate electrodes are therefore generated by the control device. An inverter module having at least six power semiconductor switches, whose connections are connected to each other in a known bridge circuit arrangement, is preferably used to generate the three-phase AC that is applied to the motor terminals of the three-phase AC drive motor.

This architecture has enormous advantages. First of all, the converter controller and the shielding thereof in commercially available inverters and frequency converters can be spared. This makes it possible for the inverter module to have very compact dimensions and be incorporated into the passenger transport system with little installation effort. Furthermore, the DC circuit is additionally used as a signal line such that signal lines between the controller and the inverter module are largely unnecessary.

Because the computing power of processors and the memory capacity of main memory have been increased steadily in recent years, even the control devices equipped with low-cost processors are significantly oversized with respect to the usual amount of data to be processed. The data to be processed originates, for example, from sensors, encoders, pulse generators, speed monitors, light barriers, safety switches, input units and the like, which are built into a passenger transport system to enable and monitor secure operation. By implementing the functions usually provided by the converter controller in the control device, the free computer capacity, main memory capacity and memory capacity of the non-volatile memory of the control device, which were present anyway, can be used to generate the trigger signals of the gate electrodes. Of course, volatile memories can also simultaneously or alternatively be used for this purpose, which therefore allow for remote control, for example via the Internet.

The implementation of the converter controller functions in the control device leads to a reduction of interfaces and to the additional flexibility of the whole power supply of the three-phase AC drive motor, because no third-party specifications regarding the generation of control signals for triggering the power semiconductor switches—as made, for example, by manufacturers of commercial frequency converters and inverters—must be taken into account for their converter controller to receive the input signals in the correct form. The implementation also increases the reaction rate of the control device as a whole because, as described above, there are fewer interfaces.

Even if the control device generates the trigger signals of the gate electrodes, the inverter module can be arranged at a sufficient distance from the control device such that the waste heat of the inverter module (hot air, radiant heat) does not adversely affect the control device.

Because the inverter module is significantly smaller than a commercial inverter having the same power due to the absence of a converter controller and, when arranged at a distance from the control device, the inverter module, due to the at least greatly-reduced shielding and cooling, can also be housed in the spaces of the passenger transport system, which were present anyway, much more easily. In addition, its waste heat can be used, for example, to prevent the formation of condensate in the interior of an escalator or moving walkway or in the elevator shaft. The revolving handrails common on escalators and moving walkways can also, for example, be heated with an inverter module arranged in the balustrade base and/or with the rectifier module described below such that the handrail has a pleasant temperature for the users and is always dry. Of course, the step belt of the escalator or the pallet belt of the moving walkway can be heated if the inverter module and/or the rectifier module are arranged below the step belt or pallet belt.

As mentioned above, the inverter module is connected to a DC voltage source on the input side. This DC voltage source can, for example, be a photovoltaic system having a DC power storage device. The photovoltaic system can, for example, be installed on the roof of the building in which the passenger transport system is installed. The DC power storage device serves to compensate for power fluctuations of the photovoltaic system. This can, for example, be a storage battery or a capacitor having a high storage capacity (supercapacitor).

Instead of the photovoltaic system, the passenger transport system can have a rectifier module that serves as a DC voltage source. The rectifier module is connected to a power supply network on the input side and to the inverter module on the output side.

Because passenger transport systems can also generate electrical energy depending on the conveying direction and load by means of the three-phase AC motor, the rectifier module can also preferably be controllable to feed the electrical energy of the DC voltage circuit back to a power supply network. Like the inverter module, a controllable rectifier module also has power semiconductor switches. The gate electrodes of the power semiconductor switches of the controllable rectifier module can also be triggered directly by the control device of the passenger transport system. Of course, the control device must be fed information about the frequency and the zero crossing of the phases of the power supply network to synchronize the controllable rectifier module, which serves as the inverter module, with the power supply network while the electrical energy is fed back.

The controllable rectifier module is connected to a power supply network on the input side and to an inverter module on the output side such that there is a DC voltage circuit between the two modules. Of course, a combination of the aforementioned DC voltage sources is also possible such that the inverter module of the passenger transport system is connected to a DC voltage circuit on the input side, the DC voltage circuit being fed by a photovoltaic system, a controllable rectifier module and, if applicable, by one or more DC power storage devices. Instead of or in addition to the photovoltaic system, a wind power plant or a small-scale hydroelectric power station can also be connected to the DC voltage circuit.

As already mentioned, there is a DC voltage circuit between the inverter module and the DC voltage source. To smooth the DC voltage in the DC voltage circuit, at least one capacitor and/or one inductive load can be arranged in the DC voltage circuit.

In addition, a monitoring module can be arranged in the DC voltage circuit. Due to the monitoring signals of the monitoring module, corresponding control voltages can be generated by the control device for the controllable rectifier module such that either electrical energy from the power supply network is fed to the DC voltage circuit or electrical energy from the DC voltage circuit is fed to the power supply network.

Control signals that can be modulated to the DC voltage circuit can also be generated by the control device for the controllable rectifier module analogously to the inverter module. The controllable rectifier module then has, like the inverter module, a demodulator. The demodulator can convert the control signals to control voltages associated with the individual gate electrodes of the power semiconductor switches. Even if the control voltages applied to the gate electrodes are only generated in the demodulator, the gate electrodes are still connected directly to the control device because there is only a direct conversion of control signals into control voltages in the demodulator and not the calculation and generation of the individual control voltages or control voltage curves. The control signals generated by the control device are, for example, pulses of different frequencies, each power semiconductor switch being associated with a certain frequency. In the demodulator, the amplitude level of this associated frequency is then used, for example, as a useful signal and the amplitude level is converted to a control voltage that is applied to the gate electrode of the associated power semiconductor switch.

To distribute the waste heat in the passenger transport system, the inverter module can, for example, be arranged in the vicinity of the three-phase AC drive motor and the rectifier module in the vicinity of the control device.

If the passenger transport system is an escalator or moving walkway, the inverter module can, for example, be arranged in a first balustrade base and the rectifier module in a second balustrade base of the escalator or moving walkway such that revolving handrails that are guided into the balustrade base can be heated by the waste heat of the rectifier module or the inverter module. Of course, the rectifier module can also be arranged in a first deflection region of the escalator or moving walkway, the inverter module can be arranged in a second deflection region of the escalator or the moving walkway and the controller can be arranged in an external control cabinet. The step belt of the escalator or the pallet belt of the moving walkway can, for example, also be heated using the waste heat of the inverter module and rectifier module.

If the passenger transport system is an elevator system, the inverter module can, for example, be arranged in an elevator shaft of the elevator system and the rectifier module in a door jamb of a landing door of the elevator shaft.

As described above, the inverter module and the controllable rectifier module can be directly connected in various ways to the controller that is generating the control signals or control voltages. Both modules have at least six power semiconductor switches as well as a connection for the negative terminal of the DC voltage circuit and a connection for the positive terminal of the DC voltage circuit. At least the inverter module has a demodulator. Furthermore, a choking coil can be arranged in the module as an inductive load and/or at least one capacitor can be arranged in the module. Other components such as sensors of all types can also be arranged in the modules. Furthermore, for example, identical housings, identical power semiconductor switches, identical demodulators, identical connections, identical printed circuit boards and the like can be used for both modules. To save production costs, as many components of the modules as possible are preferably identical. The inverter module and the controllable rectifier module are preferably completely identical in design.

As described above in detail, the modules installed at various points of the passenger transport system form, together with the part of the controller which generates the control voltages or control signals, a decentralized modular inverter or decentralized modular frequency converter.

### DESCRIPTION OF THE DRAWINGS

The construction and arrangement of the power supply according to the invention of the three-phase AC drive motor of a passenger transport system are explained in greater detail below using examples and with reference to the drawings. The drawings show:

FIG. 1: a schematic representation of an escalator having a support structure or truss and two deflection regions, wherein a decentralized, modular frequency converter and running rails are arranged in the support structure, and a revolving step belt is arranged between the deflection regions;

FIG. 2: a schematic representation of a moving walkway having a support structure and two deflection regions, wherein a decentralized, modular frequency converter and running rails are arranged in the support structure and a revolving pallet belt is arranged between the deflection regions;

FIG. 3: a schematic representation of a part of a multi-story building having an elevator system with a decentralized, modular frequency converter;

FIG. 4: a schematic representation, but in more detail, of the structure of the decentralized, modular frequency converter shown in FIG. 3; and

FIG. 5: a schematic representation, but in more detail, of the structure of the decentralized, modular frequency converter shown in FIG. 1.

### DETAILED DESCRIPTION

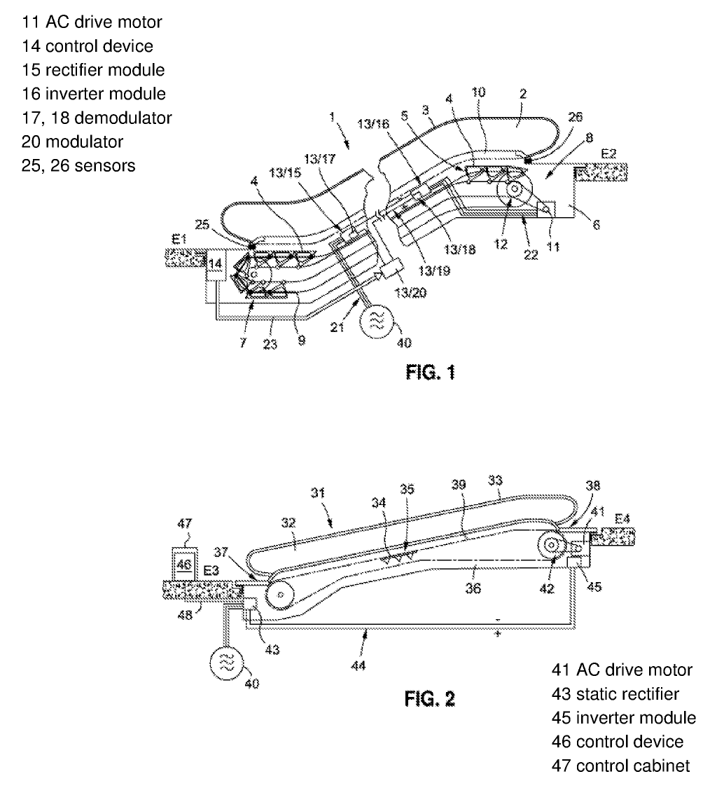

FIG. 1 schematically shows a side view of an escalator 1 serving as a passenger transport system that connects a first level E1 with a second level E2. The escalator 1 has a support structure 6 or truss 6 that is only illustrated by contour lines, having two deflection regions 7, 8, between which a step belt 5 is guided in a revolving manner. The step belt 5 has pulling means 9 on which steps 4 are arranged. A handrail 3 is arranged on a balustrade 2. The balustrade 2 is connected to the support structure 6 at the lower end by means of a balustrade base 10. The escalator 1 actually has two balustrades 2, only one balustrade 2 being visible in the side view.

The escalator 1 also has a three-phase AC drive motor 11, by means of which the step belt 5 is driven via a step-down drive train 12 or via a reduction gear 12. The three-phase AC drive motor 11 is supplied with electrical energy from a power supply network 40. A modular frequency converter 13, which has a controllable rectifier module 15 with power semiconductor switches (not shown), a DC voltage circuit 19, as well as an inverter module 16 with power semiconductor switches (not shown), is arranged between the power supply network 40 and the three-phase AC drive motor 11. The connection line 21 between the power supply network 40 and the controllable rectifier module 15 is of at least three-phase construction. The same is true for the connection line 22 between the inverter module 16 and the three-phase AC drive motor 11. Both the inverter module 16 and the controllable rectifier module 15 are arranged underneath the handrail 3 in the balustrade base 10 such that their waste heat heats the returning section of the handrail 3. Because each escalator 1 and each moving walkway has two revolving handrails 3 whose returning sections are each guided inside of a balustrade base 10, the inverter module 16 is preferably arranged in the one balustrade base 10 and the controllable rectifier module 15 is preferably arranged in the other balustrade base 10 such that both handrails 3 can be heated with waste heat.

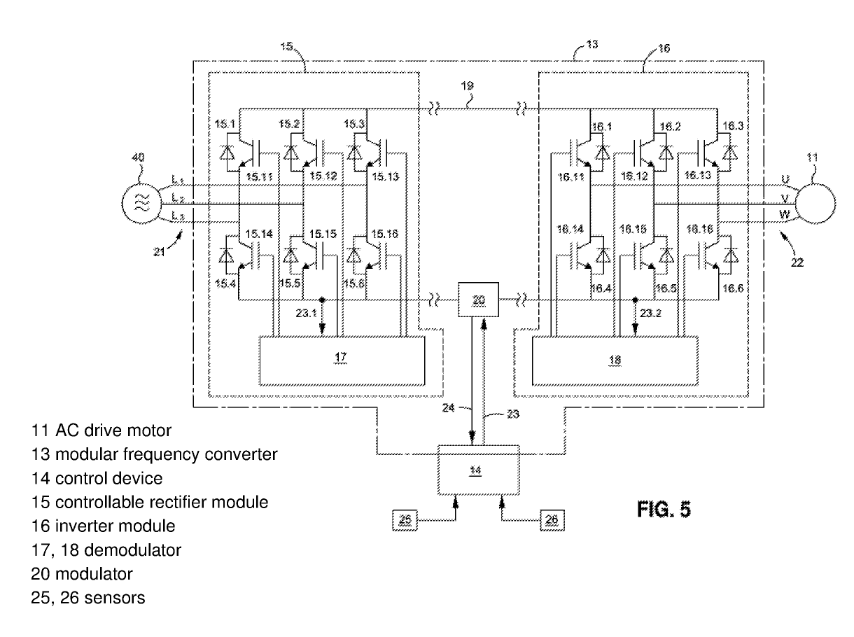

The controllable rectifier module 15 and the inverter module 16 each have a demodulator 17, 18 that receives control signals for triggering the gate electrodes of the power semiconductor switches via the DC voltage circuit 19. The control signals are modulated to the DC voltage circuit 19 by means of a modulator 20. The modulator 20 receives the control signals via a signal line 23 from a control device 14 that is arranged in the deflection region 7 of the first level E1. A more detailed description is made below in connection with FIG. 5.

The control device 14 generates the control signals by means of algorithms stored in the control device 14 and taking into account operation signals processed in the control device 14. These operation signals originate from, for example, sensors 25, 26 that detect the approach of a user. Other operation signals can originate from encoders, safety switches, pulse generators, speed monitors, radar sensors, light barriers, input units and the like, which are built into a passenger transport system to enable and monitor secure operation.

FIG. 2 schematically shows a side view of a moving walkway 31 serving as a passenger transport device and having a similar design to the escalator 1 shown in FIG. 1. The moving walkway 31 has two balustrades 32 (only one is visible in the side view) with a balustrade base and handrail 33, a support structure 36 and two deflection regions 37, 38. In contrast to the escalator 1 of FIG. 1, it is not a step belt, but a pallet belt 35 that is arranged between the deflection regions 37, 38 of the moving walkway 31. The pallet belt 35 has pulling means 39 on which pallets 34 are arranged. Link chains, belts, ropes and the like, for example, can be used as pulling means 39. The moving walkway 31 connects, for example, a third level E3 with a fourth level E4. However, the moving walkway 31 can also connect two areas of a building that are on the same level or floor. Such moving walkways 31 are, for example, often installed in airport buildings.

The moving walkway 31 also has a three-phase AC drive motor 41, by means of which the pallet belt 35 is driven via a step-down drive train 42 or via a reduction gear 42. The three-phase AC drive motor 41 is supplied with electrical energy from a power supply network 40.

The moving walkway 31 of the present exemplary embodiment only climbs a small height, which is why only a small amount of braking power must be provided by the three-phase AC drive motor 41 if users are being conveyed downward. This is why only a very small amount of brake energy accrues that could be fed back to the power supply network 40. For this reason, a static rectifier 43 is provided that is connected to the voltage source 40 on the input side and to a DC voltage circuit 44 on the output side. The static rectifier 43 is arranged in the deflection region 37 of the third level E3.

An inverter module 45 is arranged in the deflection region 38 of the fourth level E4, in which the three-phase AC drive motor 41 is also housed. The inverter module 45 is connected to the DC voltage circuit 44 on the input side and to the three-phase AC drive motor 41 on the output side. Thus, the DC voltage circuit 44 extends between the two deflection regions 37, 38 of the moving walkway 31. For the sake of greater clarity, the two current-carrying cable strands or cables of the DC voltage circuit 44 are arranged outside of the support structure 36. Of course, the current-carrying cable strands of the DC voltage circuit 44 can also be arranged in the support structure 36.

Furthermore, the moving walkway 31 has a control device 46 that is housed in a separate control cabinet 47. A demodulator (not shown) is arranged in the rectifier module 43. This demodulator is connected directly to the control device 46 via a signal line 48. The signals generated by the control device 46 for triggering the power semiconductor switches arranged in the inverter 45 can thus be transmitted to a demodulator of the inverter 45 via the DC voltage circuit 44. The control voltages applied to the gate electrodes of these power semiconductor switches are generated in the demodulator from the control signals of the control device 46.

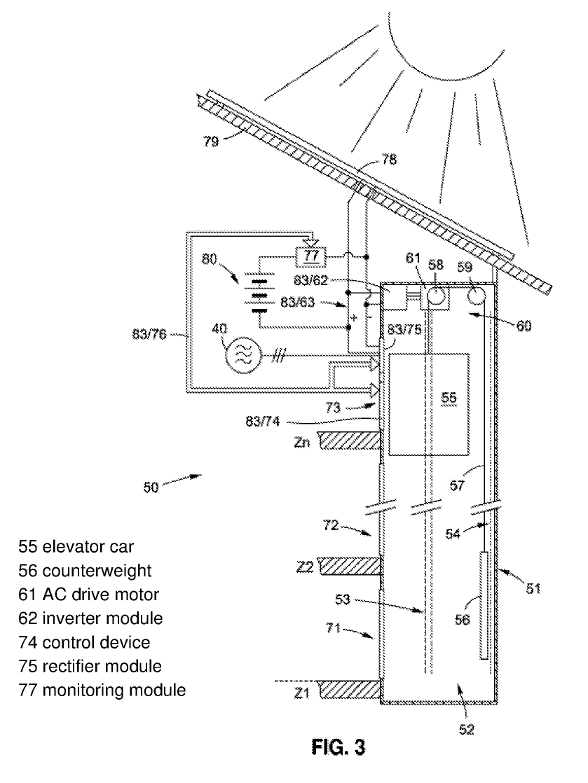

FIG. 3 schematically shows a part of a multi-story building 50 having an elevator system 51 serving as a passenger transport system. The elevator system 51 vertically connects several floors Z1, Z2 . . . Zn of the building 50. The elevator system 51 comprises an elevator shaft 52 having vertically arranged guide rails 53, 54 along which an elevator car 55 and a counterweight 56 are linearly guided. The elevator car 55 and the counterweight 56 are connected to each other by a support means 57. The support means 57 is guided via a drive pulley 58 and a deflection pulley 59, which are arranged in the shaft head 60 of the elevator shaft 52. Furthermore, an inverter module 62 and a three-phase AC drive motor 61 are also arranged in the shaft head 60, by means of which the drive pulley 58 can be driven. The inverter module 62 is connected to the three-phase AC drive motor 61 on the output side and to a DC voltage circuit 63 on the input side.

The elevator car 55 can be entered or exited via landing doors 71, 72, 73, which are arranged on each floor Z1, Z2 . . . Zn and separate the respective floor Z1, Z2 . . . Zn from the elevator shaft 52. The landing doors 71, 72, 73 have door jambs made of hollow profiles with a door jamb interior. A control device 74 and a controllable rectifier module 75 are arranged in the door jamb interior of the landing door 73 arranged on the top floor Zn. The controllable rectifier module 75 is connected to a power supply network 40 on the input side and to the DC voltage circuit 63 on the output side. The control device 74 generates control signals to directly trigger the gate electrodes of power semiconductor switches arranged in the controllable rectifier module 75 and in the inverter module 62.

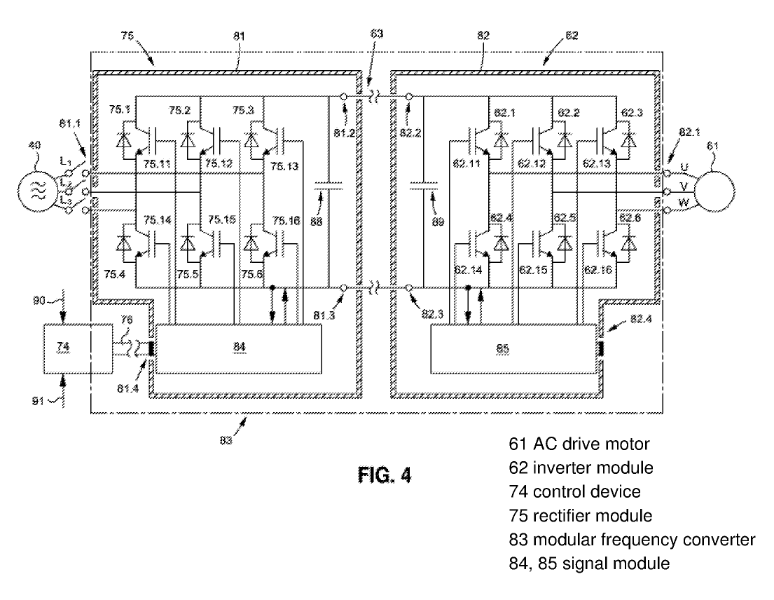

The control signals are transmitted from the control device 74 to the controllable rectifier module 75 by means of a field bus 76. A modulator, a demodulator and a bus node (not shown) are arranged in the controllable rectifier module 75. These three data transmission elements are collectively referred to as a signal module 84, 85 in the description of FIG. 4.

The control signals generated for the inverter module 62 arranged in the elevator shaft 52 are modulated to the DC voltage circuit 63 via the modulator of the rectifier module 75 and converted to control voltages by the demodulator arranged in the inverter module 62 for its power semiconductor switches.

Other devices such as sensors, safety switches for monitoring the landing doors 71, 72, 73, the shaft information system, which measures the position of the elevator car 55 in the elevator shaft 52, and the like can also be connected to the field bus 76 provided that they have a bus node or master node. These other devices mentioned above and their use are known per se and are therefore not shown in FIG. 3.

In the present exemplary embodiment, a monitoring module 77, by means of which the voltage is regulated in the DC voltage circuit 63, is connected to the field bus 76. The DC voltage circuit 63 is not only fed via the controllable rectifier module 75, but also by a photovoltaic system 78 that is arranged on the roof 79 of the building 50. There is also a power storage device 80 in which electrical energy can be stored. In the present exemplary embodiment, this is a storage battery, but it can also, of course, be a different power storage device 80, such as a capacitor. Of course, electrical energy from the DC voltage circuit 63 can also be fed to or fed back to the power supply network 40 by the controllable rectifier module 75. To ensure that the control device 74 receives all of the operation signals, these signals can be transmitted from the individual bus nodes of the modules 75, 77 and devices connected to the field bus 76 to the control device 74, which is why the field bus 76 is schematically shown as a double-headed arrow.

The controllable rectifier module 75, the DC voltage circuit 63 and the inverter module 62, together with the field bus 76 and the part of the control device 74 that generates the control voltages for the gate electrodes, form a decentralized, modular frequency converter 83, which is why these components each have two reference numbers separated by a slash. A more detailed description of this decentralized, modular frequency converter 83 is given below in connection with FIG. 4, in which the modular decentralized frequency converter 83 is delimited by the dot and dash line.

FIG. 4 shows a schematic representation, but in more detail, of the structure of the modular frequency converter 83 shown in FIG. 3. Accordingly, the same reference numbers are also used. For the sake of greater clarity, the power storage device 80 and the monitoring module 77 are not shown.

The dot and dash line comprises all components of the decentralized modular frequency converter 83. The controllable rectifier module 75 and the inverter module 62 each have a housing 81, 82. The housings have connections 81.1, 81.2, 81.3, 81.4, 82.1, 82.2, 82.3, 82.4 on the input side and output side.

The controllable rectifier module 75 has six power semiconductor switches 75.1 to 75.6. The power semiconductor switches 75.1 to 75.6 are connected to each other in a known bridge circuit arrangement, as well as to the phases L₁, L₂, L₃ of the power supply network 40 through a contactor on one side and to the DC voltage circuit 63 on the other side. The gate electrodes 75.11 to 75.16 of the power semiconductor switches 75.1 to 75.6 are connected to a signal module 84. The signal module 84 includes a bus node, a modulator and a demodulator. Control signals are transmitted from the control device 74 to the signal module 84 via the serial field bus 76. In the signal module 84, the control signals representing control voltages intended for the controllable rectifier module 75 are converted into control voltages assigned to the individual gate electrodes 75.11 to 75.16. Furthermore, the control signals intended for the inverter module 62 are modulated to the DC voltage circuit 63, symbolized by the two arrows shown between the DC voltage circuit 63 and the signal module. As the two arrows show, it is not only possible to modulate signals to the DC voltage circuit 63, but it is also possible for signals in the DC voltage circuit 63 to be retrieved by the demodulator of the signal module 84 and transmitted to the control device 74 via the bus node and the field bus 76.

Even if the control voltages applied directly to the gate electrodes 75.11 to 75.16 are only generated in the signal module 84, the gate electrodes 75.11 to 75.16 are still connected directly to the control device 74 because there is only a direct conversion of control signals into control voltages in the signal module 84 and not the calculation and generation of the individual control voltages or control voltage curves to influence or control the conducting behavior of the associated power semiconductor switches 75.1 to 75.6.

The control signals generated by the control device 74 are transmitted in a known manner in digital form via the field bus 76 to the signal module 84 of the controllable rectifier module 75. This is why the dot and dash line of the decentralized modular frequency converter 83 also comprises a part of the control device 74. The controllable rectifier module 75 may also have other elements, such as the depicted capacitor 88 for smoothing the DC voltage that is present between the connections 81.2 and 81.3 during the operation of the passenger transport system.

Like the controllable rectifier module 75, the inverter module 62 also has six power semiconductor switches 62.1 to 62.6 and a signal module 85 with a modulator, demodulator and bus nodes. As in the case of the controllable rectifier module 75, the power semiconductor switches 62.1 to 62.6 of the inverter module 62 are also connected to each other in a known bridge circuit arrangement, as well as connected to the terminals U, V, W of the three-phase AC drive motor 61 on one side and to the DC voltage circuit 63 on the other side. The gate electrodes 62.11 to 62.16 of the power semiconductor switches 62.1 to 62.6 are connected to a signal module 85.

Even though the rectifier module 75 already has a capacitor for smoothing the DC voltage, the inverter module 62 also includes a capacitor 89. The physical design of the inverter module 62 is preferably absolutely identical to the physical design of the controllable rectifier module 75.

This has enormous manufacturing advantages because only two identical modules 62, 75 need to be connected to each other through their DC voltage-carrying connections 81.2, 82.2 and 81.3, 82.3 to create a fully functional frequency converter 83. Furthermore, only one of the signal modules 84, 85 needs to be connected to the control device 74. It is thus evident that, instead of the signal module 84 of the rectifier module 75, the signal module 85 of the inverter module 62 can be connected to the field bus 76, wherein it is logically necessary to at least modulate the control signals for the controllable rectifier module 75. Because the market needs tens of thousands of passenger transport systems of the aforementioned type every year, a large number of the same modules 62, 75 can be manufactured and at a very low cost thanks to economies of scale.

It is also possible that other signals transferred from the field bus 76 that are not intended to trigger the inverter module 62 are modulated to the DC circuit 63 by the signal module 84 of the rectifier module 75. At least a portion of these signals can be demodulated in the signal module 85 and passed on to other devices, such as sensors, output devices such as monitors, and safety switches for monitoring the landing doors 71, 72, 73 via the bus node of the signal module 85 via a further field bus that can be connected to the connection 82.4. Of course, the signal transmission also works in the opposite direction such that the DC circuit 63 at least partly takes on the function of a field bus.

The control device 74 generates the bus signals representing control voltages by means of algorithms stored in the control device 74 and taking into account operation signals processed in the control device 74, such as input signals 90 and measuring signals 91. The input signal 90 originates, for example, from an input terminal (not shown). The measuring signal 91 originates, for example, from a shaft information system (not shown) of the elevator system 50 shown in FIG. 3.

As soon as a user of the elevator system calls the elevator car 55, for example, to his level Z1 via the input terminal, an input signal 90 is transmitted to the control device 74. The control device 74 calculates the control voltages to be fed to the gate electrodes 62.11 to 62.16 of the inverter module 62 or chronologically calculates the control voltage curves taking into account the position of the elevator car 55 in the elevator shaft 52 transmitted by the measuring signal 91 such that the elevator car 55 is accelerated, moved and braked by the three-phase AC drive motor 61. The control voltage curves associated with the individual gate electrodes 62.11 to 62.16 that were calculated by the control device 74 make it possible, for example, to softly accelerate and brake the elevator car 55, accelerate the elevator car 55 while saving as much energy as possible, etc.

FIG. 5 shows a schematic representation, but in more detail, of the structure of the decentralized modular frequency converter 13 shown in FIG. 1. Accordingly, the same reference numbers are also used. The dot and dash line comprises all components of the modular frequency converter 13. The controllable rectifier module 15 and the inverter module 16 are delimited with broken lines. The controllable rectifier module 15 has six power semiconductor switches 15.1 to 15.6. The power semiconductor switches 15.1 to 15.6 are connected to each other in a known bridge circuit arrangement, as well as to the phases L₁, L₂, L₃ of the power supply network 40 on one side and to the DC voltage circuit 19 on the other side. The gate electrodes 15.11 to 15.16 of the power semiconductor switches 15.1 to 15.6 are connected to the demodulator 17. Via the connection 23.1, the demodulator reads off the control signals modulated to the DC voltage circuit by the modulator 20 and converts them into control voltages associated with the individual gate electrodes. Of course, the energy required to convert the control signals to control voltages can be tapped via the connection 23.1 from the DC voltage circuit.

Even if the control voltages applied to the gate electrodes 15.11 to 15.16 are only generated in the demodulator 17, the gate electrodes 15.11 to 15.16 are still connected directly to the control device 14 because there is only a direct conversion of control signals into control voltages in the demodulator 17 and not the calculation and generation of the individual control voltages or control voltage curves.

The control signals 14 generated by the control device are, for example, pulses of different frequencies, each power semiconductor switch 15.1 to 15.6 being associated with a certain frequency. In the demodulator 17, the variable amplitude of this frequency is then used, for example, to generate the control voltage applied to the gate electrodes 15.11 to 15.16 of the associated power semiconductor switch 15.1 to 15.6.

The control signals required to trigger the gate electrodes 15.11 to 15.16, which are modulated to the DC voltage circuit 19 by the modulator 20, are generated directly in the control device 14 and transmitted to the modulator 20 via the control line 23. This is why the dot and dash line of the decentralized modular frequency converter 13 also comprises a part of the control device 14.

The modulator 20 can, of course, have other elements, such as sensors (not shown) by means of which the DC voltage circuit 19 can be monitored. Their signals reach the control device 14 via the signal line 24.

Like the controllable rectifier module 15, the inverter module 16 also has six power semiconductor switches 16.1 to 16.6. The power semiconductor switches 16.1 to 16.6 are connected in a known arrangement to the terminals U, V, W of the three-phase AC drive motor 11 on one side and to the DC voltage circuit 19 on the other side. The gate electrodes 16.11 to 16.16 of the power semiconductor switches 16.1 to 16.6 are connected to the demodulator 18. Via the connection 23.2, the demodulator 18 taps the control signals modulated to the DC voltage circuit 19 by the modulator 20 and converts them into control voltages associated with the individual gate electrodes 16.11 to 16.16. The physical design of the inverter module 16 is thus identical to the physical design of the controllable rectifier module 15.

The control device 14 generates the control signals by means of algorithms stored in the control device 14 and taking into account operation signals processed in the control device 14. These operation signals originate from, for example, the sensors 25, 26 that detect the approach of a user. As soon as a user approaches an escalator or a moving walkway, a signal is transmitted from the sensor 25, 26 to the control device 14. The control device 14 calculates the control voltages to be fed to the gate electrodes 16.11 to 16.16 of the inverter module 16 or chronologically calculates the control voltage curves such that it is possible, for example, to accelerate the three-phase AC drive motor 11 as gently as possible.

Although the invention has been described by showing specific exemplary embodiments, it is evident that numerous other embodiment variants can be created with the knowledge of the present invention, for example, by using a power supply of the three-phase AC drive motor in the escalator of FIG. 1 or in the moving walkway of FIG. 2, as shown in FIG. 3. Furthermore, a controlled rectifier module or a static rectifier module can be used in all exemplary embodiments.

To equip a passenger transport system of the aforementioned type having a decentralized, modular frequency converter capable of feedback, the invention requires a controllable rectifier module, an inverter module for establishing the DC voltage circuit, one connection line each for the negative terminals and the positive terminals of the modules and a transmission means for transmitting the control signals or control voltages between the control device and the inverter module or between the control device and the controllable rectifier module. Furthermore, the software needed to generate the control signals or control voltages must be implemented in the control device. The signal modules 84, 85 mentioned above do not necessarily have three areas or components physically divided into a modulator, demodulator and bus nodes. The signal module 84, 85 can be designed as a physical unit and provide only the three functions of modulator, demodulator and bus nodes.

Of course, existing passenger transport systems can also be modernized by replacing their existing inverter or frequency converter with a decentralized, modular frequency converter or inverter. Of course, the existing control device must be adapted or, if necessary, replaced such that it is capable of generating the operationally necessary control voltages of the power semiconductor switches.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A passenger transport system having a three-phase AC drive motor and a control device, wherein the control device processes operation signals of the passenger transport system and controls the three-phase AC drive motor according to the operation signals, comprising:
a DC voltage source;
an inverter module with power semiconductor switches, wherein gate electrodes of the power semiconductor switches are triggered directly by the control device, and the inverter module has an input side connected to the DC voltage source and an output side connected to the three-phase AC drive motor; and
a DC voltage circuit connected between the DC voltage source and the inverter module, wherein the control device generates trigger signals modulated to the DC voltage circuit and the inverter module has a demodulator that converts the modulated trigger signals into control voltages assigned to individual ones of the gate electrodes of the power semiconductor switches.

17. The passenger transport system according to claim 1 wherein the DC voltage source is a photovoltaic system having a DC power storage device.

18. The passenger transport system according to claim 16 wherein the DC voltage source includes a controllable rectifier module with power semiconductor switches, wherein gate electrodes of the power semiconductor switches of the controllable rectifier module are triggered directly by the control device and the controllable rectifier module has an input connected to a power supply network and an output connected to the inverter module.

19. The passenger transport system according to claim 18 including at least one of a capacitor and an inductive load arranged in the DC voltage circuit.

20. The passenger transport system according to claim 18 including a monitoring module arranged in the DC voltage circuit and wherein the control device generates control voltages to the controllable rectifier module according to monitoring signals from the monitoring module, wherein either electrical energy is fed from the power supply network to the DC voltage circuit or electrical energy is fed from the DC voltage circuit to the power supply network in response to the control voltages generated to the controllable rectifier module.

21. The passenger transport system according to claim 18 wherein the controllable rectifier module has a demodulator that converts the modulated trigger signals into control voltages that are assigned to individual ones of the gate electrodes of the power semiconductor switches of the controllable rectifier module.

22. The passenger transport system according to claim 18 wherein the control device generates control voltages applied to the gate electrodes of the power semiconductor switches of the controllable rectifier module.

23. The passenger transport system according to claim 18 the control device is connected to the controllable rectifier module via a field bus.

24. The passenger transport system according to claim 18 wherein the controllable rectifier module is arranged in a vicinity of the control device.

25. The passenger transport system according to claim 18 being an escalator or a moving walkway and wherein the inverter module is arranged in a first balustrade base and the controllable rectifier module is arranged in a second balustrade base of the escalator or the moving walkway, wherein revolving handrails guided into the balustrade bases are heated by waste heat of the controllable rectifier module and the inverter module.

26. The passenger transport system according to claim 18 being an escalator or a moving walkway and wherein a step belt of the escalator or a pallet belt of the moving walkway is heated with the waste heat of at least one of the inverter module and the controllable rectifier module.

27. The passenger transport system according to claim 18 being an elevator system wherein the inverter module is arranged in an elevator shaft of the elevator system and the controllable rectifier module is arranged in a door jamb of a landing door of the elevator shaft.

28. The passenger transport system according to claim 18 wherein the inverter module and the controllable rectifier module are identical in design.

29. The passenger transport system according to claim 16 wherein the control device is connected to the inverter module by a field bus.

30. The passenger transport system according to claim 16 wherein the inverter module is arranged in a vicinity of the three-phase AC drive motor.
